(19) United States
(12) Patent Application Publication
(10) Pub. No.: US 2026/0260506 A1
(43) Pub. Date: Sep. 3, 2026

(54) Systems, Methods and Computer Program Products for Indicating the Location of Information in Documents

(71) Applicant: XERO LIMITED, Te Aro, Wellington (NZ)

(72) Inventor: Bryan Obright, Te Aro, Wellington (NZ)

(21) Appl. No.: 19/489,477

(22) PCT Filed: May 28, 2024
(86) PCT No.: PCT/NZ2024/050058

§ 371 Date: Dec. 2, 2025

(30) Foreign Application Priority Data
Jun. 6, 2023 (AU) 2023901786

(51) Int. Cl. G06V 30/14; G06F 40/103; G06F 40/169

(52) U.S. Cl. CPC G06V 30/1444; G06F 40/103; G06F 40/169

(57) ABSTRACT

A method for displaying data to a user comprises displaying, on a display device, a display object comprising a calculated data item, the calculated data item having a value determined based on at least one component data item, the component data item extracted from a source document. The method further comprises, in response to receiving, from a user interface, a selection of the calculated data item: determining the component data item associated with the calculated data item; determining the source document associated with the component data item; displaying, on the display device, at least a portion of the source document; and visually indicating, on the display device, a location of the component data item in the source document.

### CROSS-REFERENCE TO RELATED APPLICATION(S)

This application is a 371 national stage of International Patent Application Serial No. PCT/NZ2024/050058, filed on May 28, 2024, which claims priority to Australian Patent Application Serial No. 2023901786, filed on Jun. 6, 2023, the entire contents of which are incorporated herein by reference.

### TECHNICAL FIELD

Embodiments generally relate to systems, methods and computer-readable media for indicating the location of information in a digital document. In particular, embodiments relate to the identification and location of information encoded in a digital representation of a financial document.

### BACKGROUND

Numerical and textual data may be digitally extracted from source documents and retained for digital record keeping, and for subsequent processing by processing software. For example, financial data, such as dates, financial account numbers, account balances, and transaction information may be extracted from financial documents, and subsequently processed by financial software, such as accounting, bookkeeping and auditing software. The processing software may produce calculated data, based on the data extracted from the source documents. This calculated data may be output by the processing software, for use by a user.

A user may desire to gain insight into how the processing software calculated the data that it has output for the user. In particular, a user may desire to determine which input data items, extracted from the source documents, were used by the processing software to determine the data that is output by the processing software. The user may desire this insight for auditing, verification, education or other purposes.

It is desired to address or ameliorate one or more shortcomings or disadvantages associated with the prior art, or to at least provide a useful alternative hereto.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

### SUMMARY

Systems and methods provided herein provide for the determination of the location, within a source document, of a data item that was used by a system to determine the value of a calculated date item. Furthermore, systems and methods provided herein provide for the determination of one or more calculated data items whose value was determined by a system based on the value of a data item in a source document.

According to one aspect, there is provided a method for displaying data to a user. The method comprises: displaying, on a display device, a display object comprising a calculated data item, the calculated data item having a value determined based on at least one component data item, the component data item extracted from a source document; and in response to receiving, from a user interface, a selection of the calculated data item: determining the component data item associated with the calculated data item; determining the source document associated with the component data item; displaying, on the display device, at least a portion of the source document; and visually indicating, on the display device, a location of the component data item in the source document.

In some embodiments, determining the component data item associated with the calculated data item comprises: determining a plurality of candidate component data items associated with the calculated data item; displaying, on the display device, an indication of each component data item of the plurality of candidate component data items for the user to select; and in response to receiving, from the user interface, a selection of a candidate component data item of the plurality of candidate component data items: assigning the selected candidate component data item as the component data item.

In some embodiments, the method further comprises performing an extracting process on the source document. The extracting process comprises: determining a value of the component data item; determining the location of the component data item in the source document; and
storing the value of the component data item and the location of the component data item in a data storage.

In some embodiments, the method further comprises: allocating an identifier of the component data item to the component data item; and storing the identifier of the component data item in association with the component data item in the data storage.

In some embodiments, determining the source document comprises determining the identifier of the component data item. In some embodiments, the identifier of the component data item comprises an indication of the source document.

In some embodiments, the identifier of the component data item comprises an indication of the location of the component data item within the source document. In some embodiments, the identifier of the component data item comprises a reference to the source document and the location within the source document. In some embodiments, the source document comprises a digital financial document.

In some embodiments, determining the component data item associated with the calculated data item comprises: determining an identifier of the calculated data item; and determining, based on the identifier of the calculated data item, the component data item associated with the calculated data item.

In some embodiments, the location comprises one or more of: a region of the source document; a landmark of the source document; a set of coordinates within the source document; and a page number of the source document.

In some embodiments, visually indicating the location comprises visually indicating on the at least a portion of the source document displayed on the display device.

In some embodiments, visually indicating the location comprises one or more of: highlighting text representing the component data item in the source document; underlining the text representing the component data item in the source document; altering the colour of the text representing the component data item in the source document; and annotating the source document with a visual indication of a location within the source document.

In some embodiments, the method further comprises determining the value of the calculated data item by performing an operation on at least the component data item. In some embodiments, the display object comprises an accounting record.

According to another aspect, there is provided a method comprising: displaying a source document, comprising at least one text item, the text item representing a component data item; and in response to receiving, from a user, a selection of the at least one text item: determining the component data item represented by the text item; determining at least one calculated data item whose value was determined based on component data item; and displaying, on the display device, a visual indication of the at least one calculated data item.

In some embodiments, the visual indication of the at least one calculated data item comprises an indication of the value of the calculated data item. In some embodiments, the visual indication of the at least one calculated data item comprises at least a portion of an accounting record comprising the calculated data item.

According to another aspect, there is provided a machine-readable storage medium storing instructions which, when executed by one or more processors, cause the one or more processors to perform a method described herein.

According to another aspect, there is provided a system comprising: one or more processors; and memory comprising computer executable instructions, which when executed by the one or more processors, cause the system to perform a method of described herein.

According to another aspect, there is provided a machine-readable storage medium storing instructions which, when executed by one or more processors, cause the one or more processors to perform the method of any one of the claims.

According to another aspect, there is provided a system comprising one or more processors, and memory comprising computer executable instructions, which when executed by the one or more processors, cause the system to perform the method of any one of the claims.

### BRIEF DESCRIPTION OF THE DRAWINGS

The invention will now be described with reference to the accompanying drawings, in which:

FIG. 1 is a block diagram of system for extracting and processing data represented in a digital document, according to an embodiment;

FIG. 2 illustrates a software architecture for an application configured to extract and process data from source documents, according to an embodiment;

FIG. 3 illustrates a portion of an example source document, according to an embodiment;

FIG. 4 illustrates a subset of extracted data, as output by the data extraction module in response to performing the extraction process on the source document of FIG. 3, according to an embodiment;

FIG. 5 illustrates an example statement of a bank account with TD bank, according to an embodiment;

FIG. 6 illustrates an example statement of a bank account with CAPITEC bank, according to an embodiment;

FIG. 7 illustrates an example statement of a bank account with Wells Fargo bank, according to an embodiment;

FIG. 8 illustrates a display object displayed on a graphical user interface by the application, according to an embodiment;

FIG. 9 illustrates a display object, comprising the display window of FIG. 8, as altered by the application in response to the user selecting a calculated data item, according to an embodiment;

FIG. 10 illustrates a display object, comprising the display window of FIG. 8, as altered by the application in response to the user selecting a calculated data item, according to another embodiment;

FIG. 11 illustrates the source document of FIG. 5 displayed as a display object on a user device, according to an embodiment;

FIG. 12 illustrates the source document of FIG. 6 displayed as a display object on a user device, according to an embodiment;

FIG. 13 illustrates the source document of FIG. 7 displayed as a display object on a user device, according to an embodiment;

FIG. 14 illustrates a display object, comprising a source document and a pop-up window, according to an embodiment;

FIG. 15 illustrates a data structure for storing information associated with a calculated data item, and a data structure for storing information associated with a component data item, according to an embodiment;

FIG. 16 illustrates a data structure which defines a component data item extracted from a source document, according to an embodiment;

FIG. 17 illustrates a process flow diagram for a process to visually indicate a component data item associated with a calculated data item, according to an embodiment; and

FIG. 18 illustrates a process flow diagram for a process to visually indicate a calculated data item associated with a component data item, according to an embodiment.

Various ones of the appended drawings merely illustrate example embodiments of the present disclosure and cannot be considered as limiting its scope.

### DETAILED DESCRIPTION

It is often desirable to digitise and automate the process of identifying and extracting meaning from a digital document. In particular, it is often desirable to digitise and automate the process of identifying, extracting and processing data from digital financial documents for the purposes of accounting, bookkeeping, statistical analysis, scientific and other purposes.

A system may be configured to extract and collate numerical and other data from digital documents, and to process the numerical data to calculate output data which is of value to a user.

In some embodiments, a system may be configured to extract financial data from a plurality of financial documents and other sources, and perform financial calculations on that data to produce output data which may be used for accounting purposes. For example, a system may be configured to: calculate taxable income based on a plurality of payslips; calculate interest earned within a financial year for an entity, based on a plurality of bank account statements associated with that entity; calculate expenses based on a plurality of invoices and receipts; or calculate profit based on a consideration of earnings data and expense data.

The system may be configured to perform an extraction process, in which component data items are identified and extracted from a source document, and a calculation process, in which calculations are performed on the component data items to determine calculated data items. Calculated data items are determined or calculated based on the values of one or more component data items.

For various reasons, a user may find it desirable or advantageous to be able to determine which component data item or items were used by the system to determine the value of a calculated data item. For example, users may find it advantageous to be able to readily determine what sources of input the accounting system used to determine the financial calculation.

Furthermore, a user may find it desirable or advantageous to be able to determine which source document a component data item was extracted from. Such reasons may include, but may not be limited to: for auditing purposes; for educational and training purposes; for verification or validation purposes; or for communication purposes.

In some situations, it may also be desirable or advantageous for a user to be able to uniquely identify a component data item, from which a calculated data item was calculated, from the plurality of component data items included within a source document.

Furthermore, a user may find it desirable or advantageous to be able to readily determine the location of a component data item of interest within the source document. In situations in which a source document is large, or is densely populated with information, the ease in which the user can visually identify a component data item of interest from amongst the other information provided in the document, may provide a distinct advantage to the user.

Embodiments provided herein may provide backward traceability for a user to determine the component data items from which a calculated data item was calculated. Embodiments provided herein may reduce the effort needed for a user to locate a component data item, of interest to a user, within a source document.

Furthermore, a user may find it desirable or advantageous to be able to readily determine which, if any, calculated data items were determined by an accounting system based on a data item located in a source document. Embodiments provided herein may provide forward traceability for a user to determine zero or more calculated data items determined from a component data item.

### Financial Documents

Financial documents can encode (e.g. display, represent) financial data in a variety of different forms, including variations in the layout of information in the document, variations in the form in which the data is represented, variations in the sets of data included in the document, variations in the formatting and structural styles of the alphanumeric data, variations in the languages used, as well are other variations to the content or form of the data.

For example, data may be tabulated, text can be provided in multiple rows, the document may include headers, and the document may include non-data elements such as borders or white-space, which convey meaning to the reader. Such variations in form and content add complexity to the design of automated processes for extracting and categorising data that is represented within a financial document.

It is common for financial institutions to issue a variety of different types of financial documents (e.g. bank statement, credit card statement, investment portfolio summary, account transaction summary), each financial document comprising different sets of data, and presenting data in accordance with a different template. Furthermore, it is common for each financial institution to present data in a template that is unique to that financial institution. Thus, the financial document issued by one financial institution may differ visually, and in terms of content and layout, from the financial document issued by another financial institution. Furthermore, a financial institution may use a variety of different templates for the same type of financial document.

### System Block Diagram

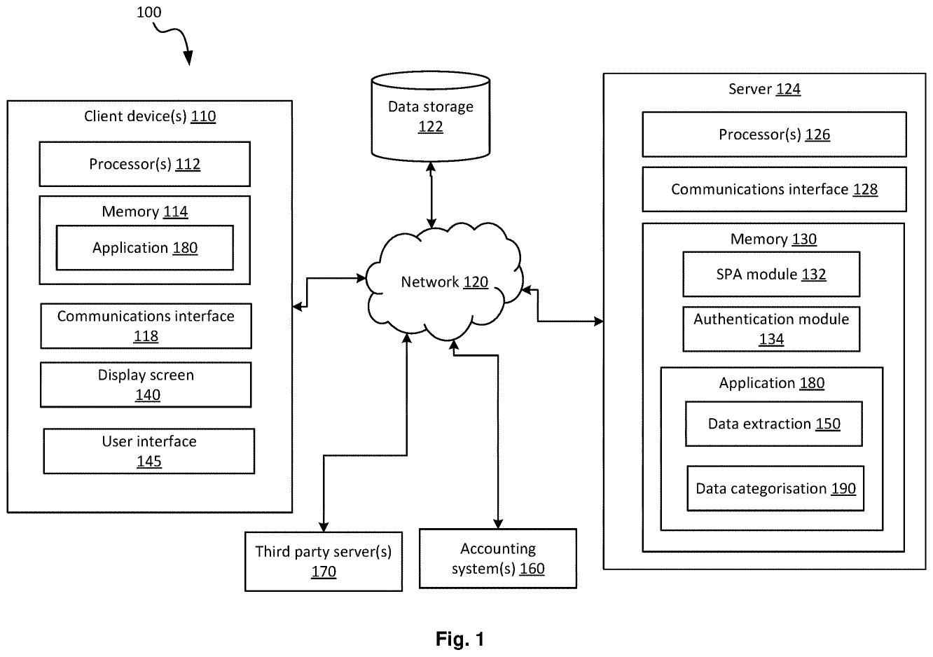

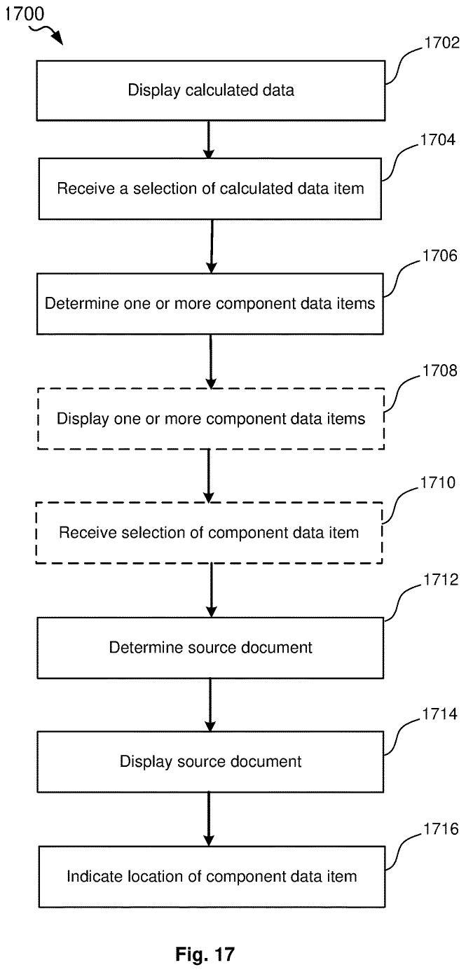

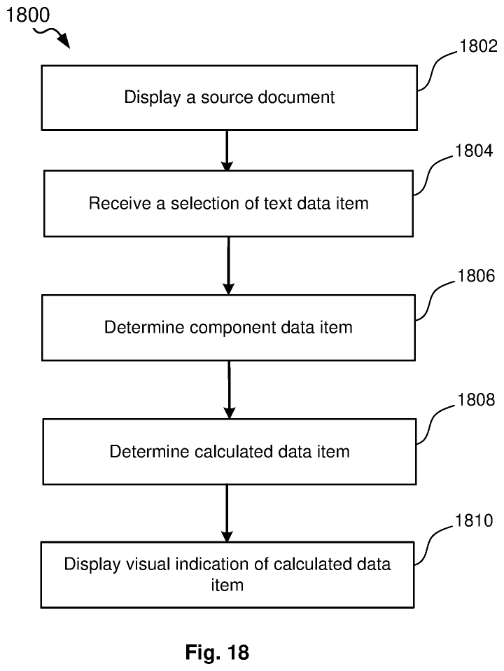

FIG. 1 is a block diagram of system 100 for extracting and processing data represented in a digital document, according to an embodiment. The system 100 of FIG. 1 provides means for implementing the method illustrated in the process flow diagrams of FIG. 17 and FIG. 18.

As illustrated, the system 100 may comprise: one or more client device(s) 110; external data storage 122; data presentation server 124; one or more accounting system(s) 160 and/or one or more third party server(s) 170 in communication over a network 120.

Client device 110 may comprise a mobile or handheld computing device such as a smartphone or tablet, a laptop, or a PC, and may, in some embodiments, comprise multiple computing devices. The client device 110 may comprise a non-transitory machine-readable storage medium storing instructions executed by one or more processor(s) 112, memory 114 and/or communications interface 118. The processor(s) 112 may comprise one or more microprocessors, central processing units (CPUs), application specific instruction set processors (ASIPs), application specific integrated circuits (ASICs) or other processors capable of reading and executing instruction code. The processor(s) 112 may be configured to receive stored instructions (i.e. program code) from memory 114, which when executed by the processor(s) 112 may cause the client device 110 to function according to the described embodiments. Client device 110 comprises one or more display devices 140, the or each of the one or more display device 140 being configured to display the GUI in implementing a method, such as that illustrated in FIG. 17 or FIG. 18. A display device may comprise one or more individual display screens.

Functionality determining arrangement and content of the GUI is provided by the processor 112 hardware, and the memory 114 hardware, which may be cooperating with data presentation server 124 and/or accounting system 160.

The functionality of the system 100 may be defined by application 180. Application 180 may comprise data extraction module 150. Alternatively, data extraction module 150 may be an application separate from application 180. Application 180 may comprise data identification module 190. Alternatively, data identification module 190 may be an application separate from application 180. Application 180 may be executed, in part or in full, on client device 110. Application 180 may be executed, in part or in full, on server 124. Machine-readable code (e.g. software) defining application 180 may be stored, in part or in full, on client device 110. Machine-readable code (e.g. software) defining application 180 may be stored, in part or in full, on server 124. The application 180 may receive inputs (e.g. source documents) from data storage 122, or from other sources internal to the server 124, internal to the client device 110, or accessible over the network 120. The application 180 may store the output products in data storage 122, in memory 130, memory 114, and/or transmit the output products over network 120.

The application 180 may be a single page application served by the data presentation server 124 to the client device 110 over the network 120 and displaying content from (for example, invoices or bills), or based on data obtained from the accounting system 160.

The memory 114 may comprise application 180 which comprises computer executable code, which when executed by the one or more processors 112, is configured to allow client device 110 to facilitate the intuitive viewing and navigation of data displayed on a display device 140, such as a screen, of the client device 110. The communications interface 118 facilitates communications with components of the communications interface 118 across the network 120, such as: data storage 122, data presentation server 124, accounting system(s) 160 and/or third party server(s) 170. The communications interface 118 may comprise a combination of network interface hardware and network interface software suitable for establishing, maintaining and facilitating communication over a relevant communication channel.

The network 120 may include, for example, at least a portion of one or more networks having one or more nodes that transmit, receive, forward, generate, buffer, store, route, switch, process, or a combination thereof, etc. one or more messages, packets, signals, some combination thereof, or so forth. The network 120 may include, for example, one or more of: a wireless network, a wired network, an internet, an intranet, a public network, a packet-switched network, a circuit-switched network, an ad hoc network, an infrastructure network, a public-switched telephone network (PSTN), a cable network, a cellular network, a satellite network, a fibre-optic network, some combination thereof, or so forth.

The data storage 122 may form part of or be local to the system 100, or may be remote from and accessible to the system 100, for example, via the communications network 120. The data storage 122 may be configured to store data associated with the system 100. The data storage 122 may be a centralised data storage. The data storage 122 may be a mutable data structure. The data storage 122 may be a shared data structure. The data storage 122 may be a data structure supported by data storage systems such as one or more of PostgreSQL, MongoDB, and/or ElasticSearch. The data storage 122 may be configured to store a current state of information or current values associated with various attributes (e.g., “current knowledge”).

The data presentation server 124 may be configured to serve single page applications to the client device 110. Single page applications may comprise GUIs. The GUIs of single page applications provide a mechanism for a user of a client device to view, navigate, manipulate, and/or interact with data stored by the accounting system 160. The data stored by the accounting system 160 may comprise, inter alia, representations of transaction data, such as digital or softcopy versions of account statements or transaction statements. The data stored by the accounting system 160 may comprise representations of financial documents, such as bank account statements, invoices, bills, receipts, issued to or by the user (or a business or other legal entity on behalf of which the accounting system 160 is providing an online bookkeeping service).

In some embodiments, the data presentation server 124 may comprise one or more processors 126 and memory 130 storing instructions (e.g. program code) which when executed by the processor(s) 126 causes the system 100 to function according to the described methods. The processor(s) 126 may comprise one or more microprocessors, central processing units (CPUs), application specific instruction set processors (ASIPs), application specific integrated circuits (ASICs) or other processors capable of reading and executing instruction code.

In some embodiments, the data presentation server 124 may operate in conjunction with or support one or more external devices, such as the client device 110, the data storage 122, the accounting system(s) 160 and/or the third party server(s) 170, to manage the provision of an intuitive GUI for stored data.

The memory 130 may comprise one or more volatile or non-volatile memory types. For example, memory 130 may comprise one or more of random access memory (RAM), read-only memory (ROM), electrically erasable programmable read-only memory (EEPROM) or flash memory. Memory 130 is configured to store program code accessible by the processor(s) 126. The program code comprises executable program code modules. In other words, memory 130 is configured to store executable code modules configured to be executable by the processor(s) 126. The executable code modules, when executed by the processor(s) 126 cause the system 100 to perform the functionality according to the described embodiments, as described in more detail below. Memory 130 may comprise a single page applications (SPA) module 132, which stores and serves single page applications (SPAs) to user devices such as client devices. Memory 130 may comprise an authentication module 134, which may, for example, check credentials to enable users to login to the service.

### Software System Architecture

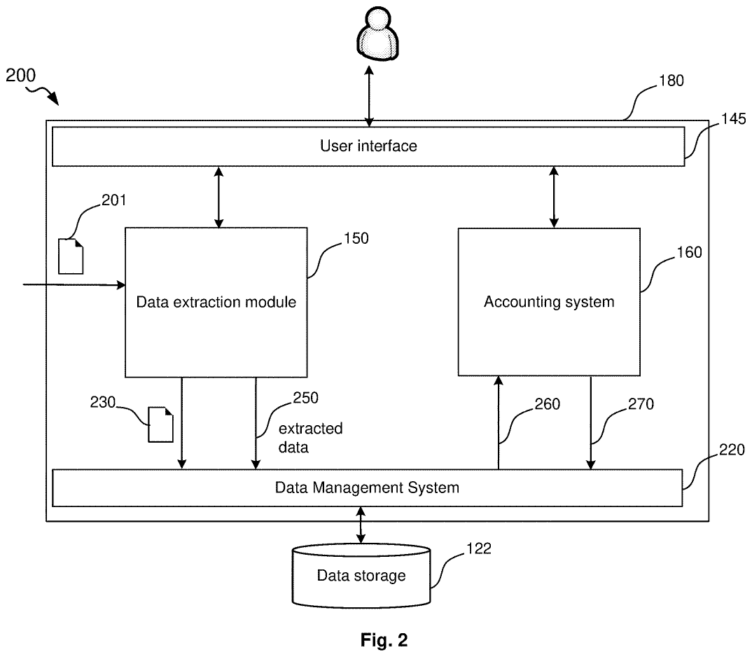

FIG. 2 illustrates a software architecture 200 for an application 180 configured to extract and process data from source documents, according to an embodiment. Software architecture 200 includes the application 180, which comprises a user interface 145, the data extraction module 150, the accounting system 160 and a data management system 220.

In other embodiments, the application 180 may comprise only some of the modules illustrated in system architecture 200. For example, in some embodiments, the accounting system 160 may be separate from application 180, and/or may be remote from application 180. In some embodiments, the software architecture 200 further comprises the data identification module 190, which is not shown in FIG. 2.

The data extraction module 150 receives, as an input, a source document 201. The source document 201 may be received from, for example, the client device 110, the data storage 122, the data management system 220, the accounting system(s) 160, or via network 120.

In some embodiments, source document 201 comprises a digital file. The digital file may be in the format of an Adobe Portable Document Format (PDF), a Joint Photographic Experts Group (JPEG) format, a Portable Network Graphics (PNG) format, a Tag Image File Format (TIFF), or another digital format.

In embodiments, the source document 201 may comprise a scanned or photographed copy of a paper hardcopy document. The source document 201 may comprise machine-encoded information, non-machine-encoded information, or a combination thereof. In some embodiments, the source document does not comprise machine-encoded text. Accordingly, an optical character recognition (OCR) module (also referred to as a character recognition module), or similar, may apply a character recognition algorithm to the source document to determine machine-readable characters represented in the source document. The machine-readable characters may comprise alpha-numerical characters, including symbols.

In some embodiments, the source document 201 comprises a financial document. In some embodiments, the source document 201 comprises: a bank statement; a tax invoice; a transaction record; a payslip; or a receipt.

### Pre-Processing

In some embodiments, the application 180 may be configured to perform a pre-processing operation on the source document 201. The pre-processing operation comprises processing the source document 201 so that the source document is suitable for the data extraction module 150 to perform the extraction process. The pre-processing operation may comprise: converting a source document of an unsupported file format to a document of a file format supported by the data extraction module 150; removing some combination of tilt, skew and page curl from the document 201; compensating for quality issues (such as insufficient pixel density, excessive noise, and/or insufficient contrast) with the source document 201; determining whether the document 201 has been altered; correcting alignment issues such that the data content of the document 201 is orientated close to a 90 degree axis; and/or removing a watermark or stamp from document 201.

### Data extraction

The data extraction module 150 parses the source document 201 to identify and extract data 250. The extracted data 250 may be stored in data storage 122 to be accessed by the accounting system 160. A copy 230 of the source document 201 may also be stored in data storage 122 to be accessed by the accounting system 160.

The data extraction module 150 may identify a plurality of data fields represented in the source document, extract the contents of each data field independently, and compose the extracted data into a normalised representation of the source document 201.

The data extraction module 150 may comprise one or more machine learning (ML) models to locate and extract data items (including alphanumeric data and symbols) from the document. The ML model may be an AI model that incorporates deep learning based computation structures, including artificial neural networks (ANNs).

In one embodiment, the data extraction process 206 is performed by a text extraction service. The text extraction service may comprise an optical character recognition (OCR) service. In one embodiment, the text extraction service comprises Amazon Textract. In one embodiment, the text extraction service comprises a combination of third party software services or libraries, and custom data extraction services or libraries.

Methods of data extraction are described in Australian provisional patent application 2023900525, which is incorporated herein, by reference.

### Example Bank Statement

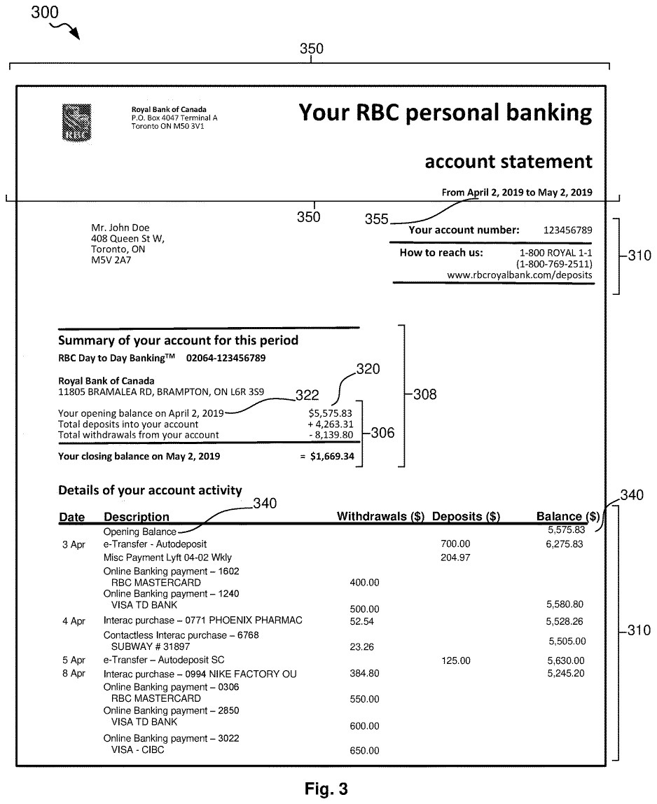

FIG. 3 illustrates a portion of an example source document 300, according to an embodiment. More particularly, source document 300 comprises a visual representation of a page of a bank statement for an example bank account held by the Royal Bank of Canada.

Source document 300 visually represents an address and name of the account holder. Furthermore, the source document visually represents a date period for which the account statement applies. Source document also visually represents a plurality of data items which are arranged in a tabular form, i.e. the data items are arranged in a plurality of columns and rows. In particular, the rows of the tabulated data items are associated with individual financial transactions that have occurred on the bank account associated with the account number. Furthermore, the columns of the tabulated data items, on the source document, are associated with various attributes of the financial transactions; namely, the posted date of the transaction, a description of the transaction, the amount of funds withdrawn (if any), the amount of funds deposited (if any) and the balance of the account in response to the occurrence of the financial transaction.

In embodiments, information represented by source documents may comprise additional attributes, fewer attributes or a different set of attributes. For example, a source document may comprise an invoice and include only data items belonging to an amount category and a description category.

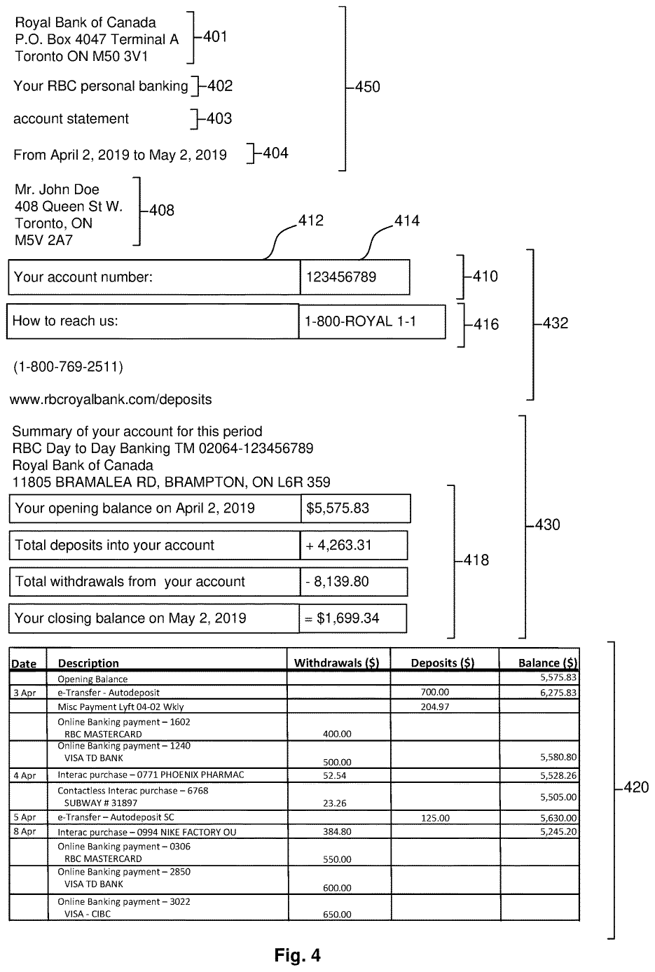

In one embodiment, the data extraction module 150 processes source document 300 to output extracted data as shown in FIG. 4.

### Extraction Outputs

FIG. 4 illustrates a subset of extracted data 250, as output by the data extraction module 150 in response to performing the extraction process on source document 300, according to an embodiment.

In one embodiment, the data extraction module 150 is configured to identify alphanumeric text in document 300 and to output a plurality of data items representing the alphanumeric text.

The data extraction module may group the alphanumeric text into sets, based on the position of the alphanumeric text in the document 300, the format of the text in document 300, or structural elements of document 300. For example, text 401 has been grouped by the data extraction module 150 because that text was closely located together in document 300.

In some embodiments, the data extraction module 150 is configured to identify and extract key-value pairs from the document 201. A key-value pair comprises text indicating a key, and corresponding text which indicates a value for the key. In FIG. 4, key-value pairs are indicated by adjacent paired boxes. For example, key-value pair 410 comprises a key 412 and a value 414 associated with that key.

In some embodiments, the data extraction module 150 is configured to identify tables in the source document 201, and extract information regarding cells, merged cells, and column headers of the tables, and extract the contents of the table cells. The data extraction module 150 may output the tabulated alphanumeric data along with information defining the tabulated structure of the data. The data extraction module may output the tabulated data in the form of comma-separated variables.

In the example of FIG. 4, the data extraction module 150 identifies data 310 as a table, and outputs tabulated data items 420.

In some embodiments, the data extraction module 150 is configured to identify and output structural information of the source document during the extraction process. Structural elements may comprise border lines, boxes, placement of non-alphanumeric features, such as images, or other visual features.

### Post-Processing

In some embodiments, the extracted data 250 extracted by the data extraction module 150 may be further processed by a post-processing module. In some embodiments, the post-processing is tailored for the processing of financial documents. In some embodiments, the post-processing process alters, adjusts or amends the extracted data 250 that was output by the data extraction module.

### Data Categories

Numerous financial institutions issue bank statements and other financial documents. Financial documents comprise important information that defines the status of a financial account on a particular date or over a particular period, and/or the activity occurring on the financial account over a particular period of time.

For accounting and booking keeping purposes, it is desirable to extract, and digitally store information from the financial document. Information contained in a financial document may be categorised into various data categories, reflecting the nature of the information with respect to the meaning and purpose of the financial document.

For example, in some embodiments, it is desirable to extract, from a bank statement, information corresponding to data categories including: the name of the bank; the branch identifier of the bank; the account number; and/or the name of the account holder. Furthermore, it is often desirable to extract, from a bank statement, information corresponding to data categories including: an opening date for the bank statement; a closing or end date for the bank statement; an opening balance; a closing balance; and/or a list of transactions that have occurred on the bank account during the period between the opening and closing dates.

In some embodiments, the application 180 performs a data categorisation process on extracted data 250 to categorise at least one of the data items into a data category.

### Data Item Identifier

In some embodiments, the application 180 is configured to identify data items extracted from a source document. The application may be configured to allocate (or assign) a data item identifier to a data item. The data item identifier for a data item may be stored in association with the data item in data storage 122. The application may be configured to allocate data item identifiers to only a subset of the data items extracted from a source document.

The data item identifier may uniquely identify the data item with regard to all other data items extracted from the same source document. The data item identifier may uniquely identify the data item with regard to all other data items stored in the data storage 122. In some embodiments, the data item identifier may include a globally unique identifier (GUID), and/or a universally unique identifier (UUID). In embodiments, the data item identifier may be immutable.

The data item identifier may comprise information associated with the data item. For example, the data item identifier may comprise: a source document identifier; a source page number; and/or an intra-document position of the data item.

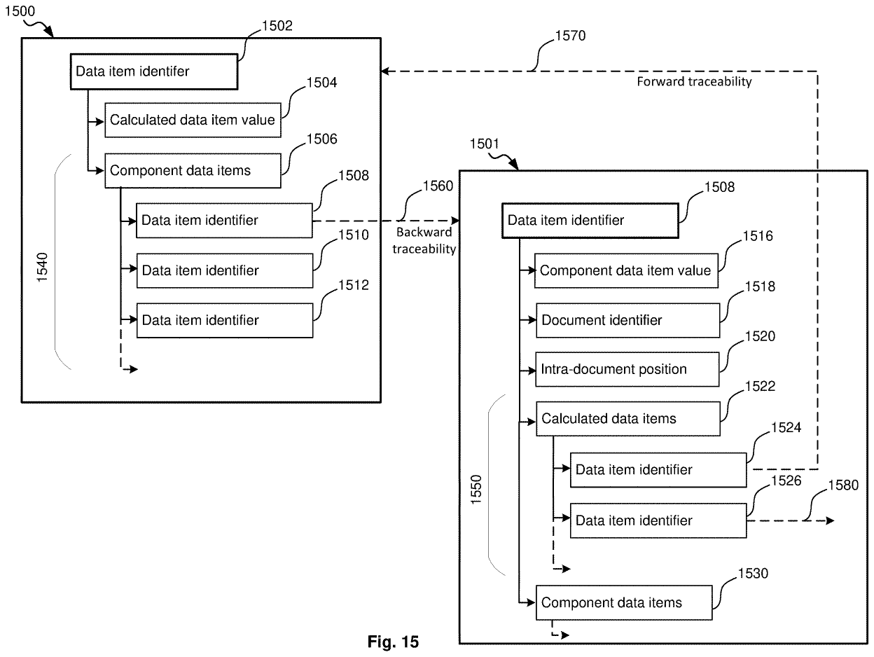

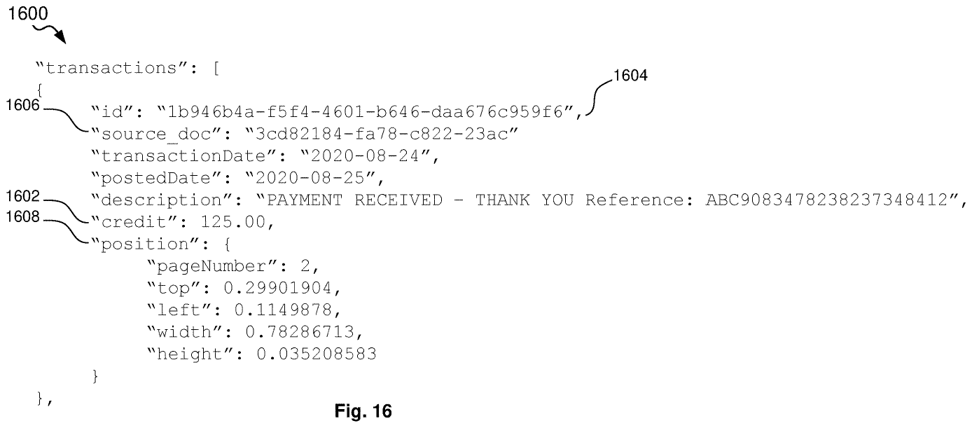

Alternatively, or additionally, the data item identifier may provide a means for the application 180 to determine information associated with the data item. For example, the data item identifier may comprise a key of a key-value pair, wherein the value comprises information associated with the data item. The key-value pair may be stored in the data storage 122. In an embodiment, the data item identifier may comprise a memory (or data storage) pointer to a data structure comprising further information associated with the data item. The data structure may comprise a data structure as described in FIG. 15 or 16.

The information associated with the data item may comprise: the value of the data item; an indication of the source document from which the data item was extracted; an indication of one or more component data items associated with the data item; and/or an indication of one or more calculated data items associated with the data item.

### Extracting Positional Information

In some embodiments, the data extraction module 150 is configured to determine the intra-document position of an extracted data item (e.g. a component data item) within the source document 201. In some embodiments, the data extraction module is configured to output, in extracted data 250, intra-document position information for an extracted data item.

In some embodiments, the data extraction module is configured to determine spatial regions within the source document and determine which spatial region a data item is positioned within. In some embodiments, the structural information extracted by the extraction module 150 comprises an indication of the inclusion of data items within spatial regions within the source document 201.

Example bank statement, document 300 of FIG. 3, comprises a header region 350, as indicated by the pair of brackets. Accordingly, the structural information may indicate that document 300 comprises a header region 350 and the header region comprises output data 450.

Similarly, the data extraction module may be configured to identify the presence of a document footer in the source document 201. In some embodiments, the data extraction module may be configured to identify the presence of a summary table in a source document 201, and the data items positioned within the summary table.

In some embodiments, the data extraction module is configured to determine the presence and location of landmarks within the document 201. Landmarks may comprise borders, logos, images, backgrounds, text or numerical landmarks, or other visual features.

The intra-document positional information for an extracted data item may comprise one or more of: a page number; coordinates within the source document; bounding regions defined in accordance with a height and a width; bounding regions defined in accordance with a list of point coordinates; positional information relative to the location of a landmark of the document; and/or positional information relative to a document boundary. Positional information may comprise an indication of structural hierarchy of the source document, including headings and heading levels.

### Stored Extracted Data

In some embodiments, the data stored in the data storage 122 for an extracted data item comprises one or more of: a value of the extracted data item; a unique identifier of the extracted data item; an indication of the source document from which the extracted data item was extracted; and an indication of a position of the extracted data item within the source document from which it was extracted.

### Accounting System

Software architecture 200 comprises an accounting system 160, configured to process the data extracted by the data extraction module 150. The accounting system retrieves, from the data storage 122, input data 260. The input data may comprise the extracted data 250 extracted by the data extraction module. The input data may further comprise accounting records 270 previously stored by the accounting system in the data storage.

The accounting system processes the input data 260, in accordance with accounting practices, to determine calculated data items. The accounting system may store the calculated data items in data storage 122, as accounting records 270. The accounting system may allocate each calculated data item with a unique data item identifier.

The accounting system 160 may be configured to consider financial data from a plurality of sources in order to perform a financial calculation. For example, an accounting system may be configured to: calculate taxable income based on income indicated on a plurality of payslips; calculate interest earned within a financial year for an entity, based on a plurality of bank account statements associated with that entity; calculate expenses based on a plurality of invoices and receipts; or calculate profit based on a consideration of earnings data and expense data.

An accounting system 160 may be configured to maintain a general ledger, in which the accounting system stores the accounting data used by the accounting system and calculated by the accounting system. The general ledger may be stored in data storage 122. Extracted data 250 extracted from a source document by the data extraction module 150 may also be stored in a general ledger.

### Component Data Items

A data item which is used by the accounting system 160 to determine (or calculate) the value of a calculated data item is considered to be a component data item, with regard to the calculated data item. A component data item may be extracted from a source document (e.g. by the data extraction module 150) or may be otherwise determined by the application 180 or the accounting system.

A calculated data item may also be a component data item if the calculated data item is used by the accounting system to determine (or calculate) the value of another calculated data item. Users may find it advantageous to be able to readily determine the one or more component data items used by the accounting system to determine a calculated data item.

### Example—Calculating Interest Paid

An example embodiment is described herein, in relation to determining an amount of interest paid to a fictitious entity “ABC Corporation” over a period of the financial year 2018/19.

It will be appreciated that, for clarity purposes, and without detracting from the full description of the invention, example embodiments described herein pertain to example usage scenarios which may comprise a more simplistic or pared-back embodiment of the invention, when compared to other usage scenarios in which the invention may be embodied. It is understood that some embodiments of the invention may include complex, layered calculations based on numerous component data items. Furthermore, it is understood that some embodiments of the invention may comprise complex user interfaces. The present embodiments are, therefore, to be considered in all respects as illustrative and descriptive of the invention, and not restrictive.

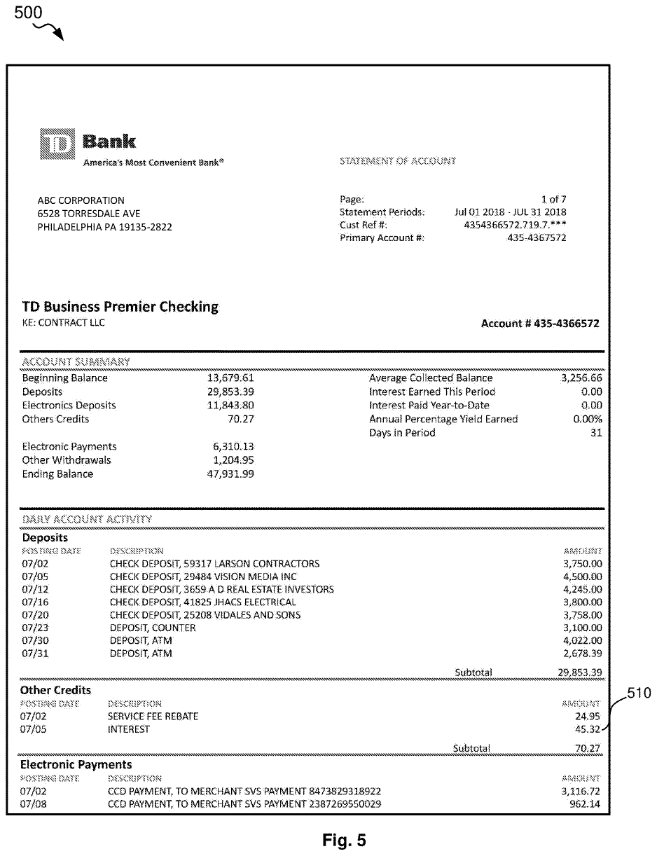

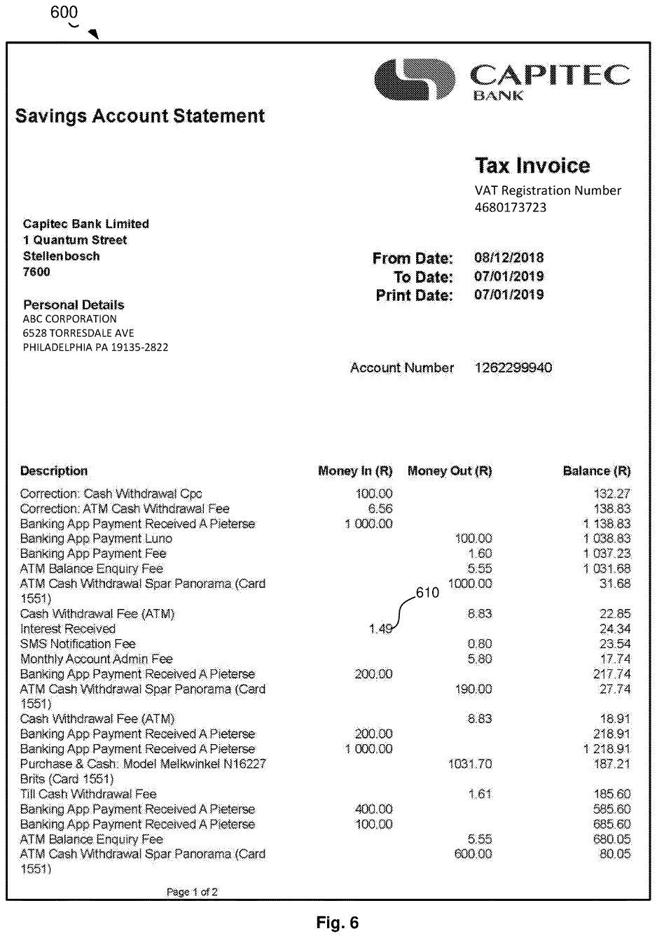

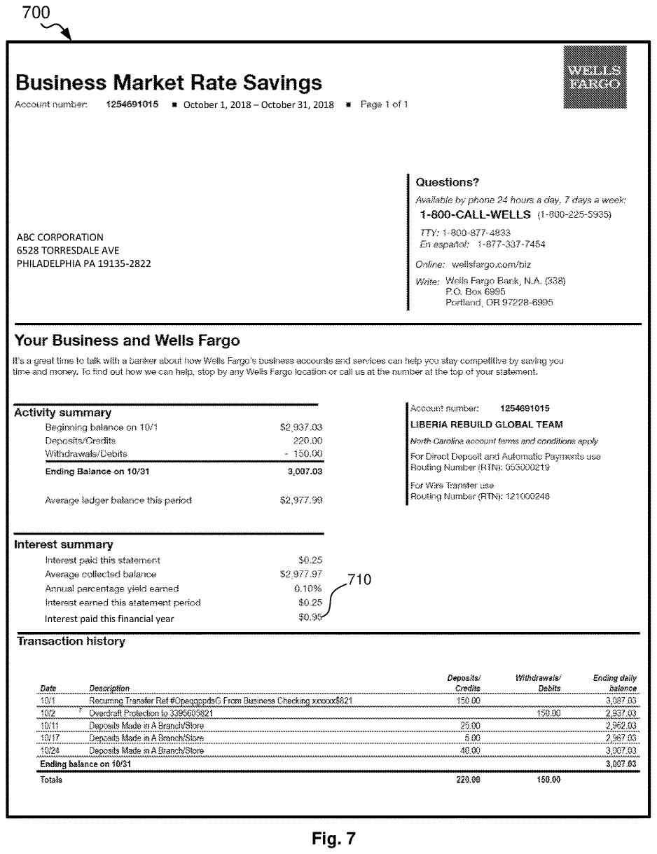

ABC Corporation has three interest earning bank accounts, including: a bank account with TD bank, a statement of which is illustrated in FIG. 5, according to an embodiment; a bank account with CAPITEC bank, a statement of which is illustrated in FIG. 6, according to an embodiment; and a bank account with Wells Fargo bank, a statement of which is illustrated in FIG. 7, according to an embodiment.

In statement, as source document 500, the interest paid is $45.32, as indicated by reference numeral 510. In statement, as source document 600, the interest paid (e.g. received) is $1.49, as indicated by reference numeral 610. In statement, as source document 700, the interest paid is $0.95, as indicated by reference numeral 710.

The data extraction module 150 processes each of the source documents 500, 600 and 700 and produces extracted data 250, which is stored in data storage 122.

Each of the account statements, source documents 500, 600, and 700, comprise information that once extracted by the data extraction module 150, will result in a large number of extracted data items to be stored in data storage 122.

The accounting system inputs the extracted data items, and calculates a calculated data item, which represents the interest paid to for ABC Corporation for the financial year 2018/19, as the sum of component data items 510, 610 and 710 (e.g. $45.32+$1.49+$0.95=$47.76).

The accounting system records the calculated data item in an accounting record 270, which may be stored in data storage 122.

### Example User Interface

In one embodiment, the application 180 is configured to display on a display device, to a user, accounting data via a graphical user interface. Accounting data may be displayed in tables within the graphical user interface. The graphical user interface may comprise display windows.

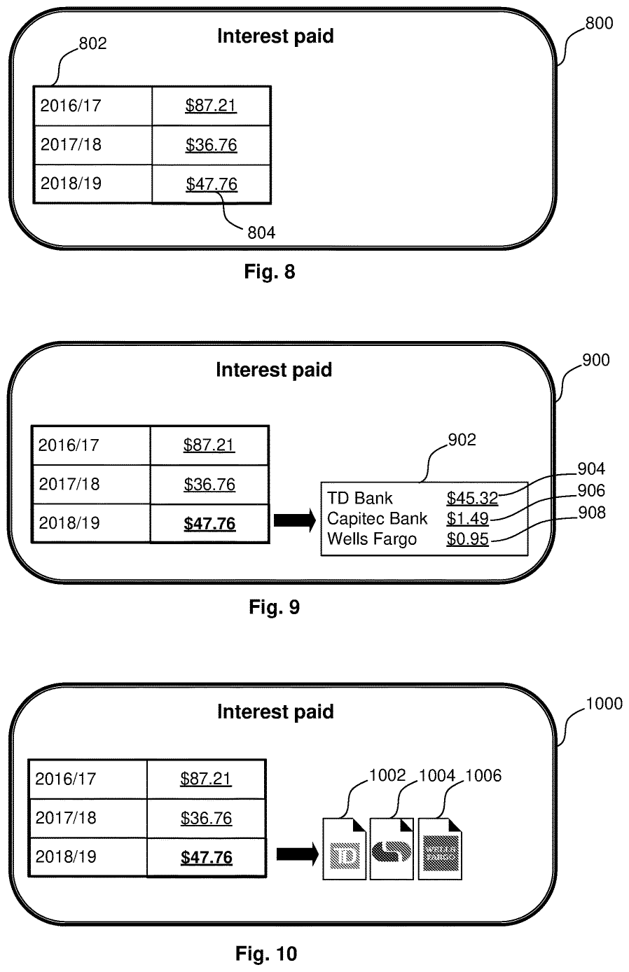

FIG. 8 illustrates a display object 800 displayed on a graphical user interface 145 by the application 180, according to an embodiment. Display object 800 comprises a display window displaying a table 802 of financial data (e.g. calculated data items). In particular, table 802 comprises the interest paid (to date) per financial year, for three consecutive financial years, for the example entity, ABC Corporation. The financial years are listed on the left hand side of the table, and the corresponding interest value is listed on the right hand side of the table.

Each of the interest values (e.g. $87.21, $36.76 and $47.76) have been calculated (e.g. by the accounting system 160) based on one or more component data items. Accordingly, each of the interest values comprise calculated data items.

Interest value, as calculated data item 804, has been calculated by the accounting system by aggregating the interest paid to each of the three interest earning bank accounts owned by ABC Corporation, example statements for which are illustrated in FIGS. 5, 6 and 7.

### Backward Traceability

In embodiments, backward traceability for a calculated data item comprises determining the component data items that were used, by the accounting system 160, to calculate the value for the calculated data item. Furthermore, backward traceability may comprise determining the source document from which each component data item was extracted.

A user of the accounting system 160 may desire to determine which component data items contributed to the determination of the value of the calculated data item. A user may desire to view the component data item in situ within the source document from which it was extracted. An application may be configured to provide that functionality by displaying a whole source document to a user. The user may then peruse the whole source document to locate the component data item. However, providing the whole source document for the user to visually peruse to locate the component data item may be undesirable, because visually perusing the whole source document can be a time-intensive, arduous and error-prone process for a user.

It will be appreciated that there are many aspects of variation across the format, layout and contents of financial source documents, as exemplified in the varied formats of the bank account statements illustrated in FIGS. 5, 6 and 7. Depending on the information density of the source document, it can be time consuming for the user, and difficult for the user to determine where the component data item is located. Furthermore, if a user identifies more than one data item that may be the component data item (e.g. two transactions for the same amount), the user may be unsure as to which data item contributed to the determination of the calculated data item.

Accordingly, displaying the source document for the user to search through to locate the component data item may not provide the level of precision and ease for backward traceability that the user desires.

In some embodiments, it is desirable to visually indicate, to the user, the location of the component data item in the source document, or at least provide the user with an indication of an area within the source document, in which the component data item is located.

### Example Backward Traceability

Referring again to the example display object 800 in FIG. 8, each of the three calculated data items (e.g. interest values) displayed may be selected by the user via the user interface. In embodiments, the user can select a displayed calculated data item by: mouse-clicking on the calculated data item; touching the screen on which the calculated data item is displayed; or hovering a mouse cursor over the calculated data item; or otherwise interacting with the user interface. In one embodiment, a user can select a calculated data item in order to determine the component data items used to calculate that interest value.

FIG. 9 illustrates a display object 900, comprising the display window of FIG. 8, as altered by the application 180 in response to the user selecting the calculated data item 804, according to an embodiment.

In display object 900, in response to the user selecting the calculated data item 804, the application 180 displays an indication 902 of the three candidate component data items from which the accounting system calculated the calculated data item 804.

In this example, the component data items comprise the three interest values $45.32, $1.49 and $0.95. For each candidate component data item (904, 906 and 908), the indication of the component data item comprises the name of the bank from which the interest was paid, and the numerical value of the interest paid. Each of the numerical values, 904, 906 and 908, illustrated in display object 900 comprise user selectable items.

In response to the user selecting one of the candidate component data items (e.g. component data item 904), the application 180 determines the source document from which component data item 904 was extracted. An example of how the application determines the source document is described in relation to document identifier 1518 of FIG. 15.

The application 180 displays, on the display device, the source document (or part thereof) from which component data item $45.32 was extracted. Similarly, in response to the user selecting item 906, the application will determine and display the source document (or part thereof) from which component data item $1.49 was extracted. Similarly, in response to the user selecting item 908, the application will determine and display the source document (or part thereof) from which component data item $0.95 was extracted.

FIG. 10 illustrates a display object 1000, comprising the display window of FIG. 8, as altered by the application in response to the user selecting the interest value, according to another embodiment. The example of FIG. 10 differs from the example of FIG. 9 in terms of the user interface provided by the application to enable the user to select the backward traceability functionality.

In the example of FIG. 10, the indication of the component data items comprises a logo of the bank from which the interest was paid. Accordingly, a user wishing to view the source document, from which the interest paid from the TD bank account was determined, may click on the TD Bank logo displayed in display object 1000.

### Indicating the Position

In one embodiment, in response to the user selecting the component data item, the application 180 is configured to display the source document, or part thereof, from which the component item was extracted, as a display object on a display device 140 of the client device 110.

To display the source document on a display device, the application may retrieve the stored source document from data storage 122.

In one embodiment, the application 180 is configured to, in response to the user selecting the component data item, visually indicate, on the display device, the location of the component data item in the source document. In one embodiment, the application is configured to visually indicate the location of the component data item in the source document by displaying a position indication. In one embodiment, the application is configured to visually annotate the source document with the position indication.

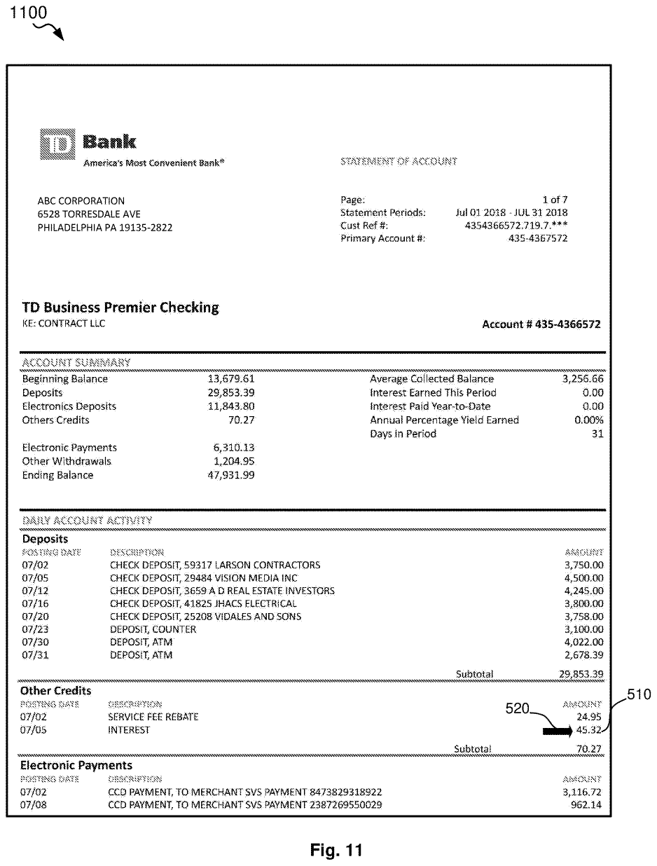

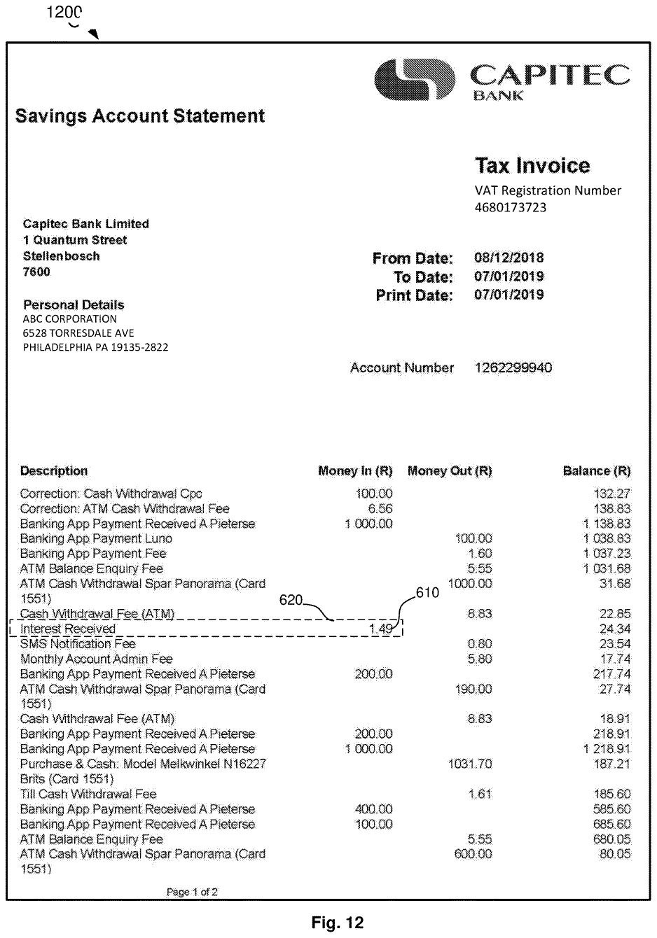

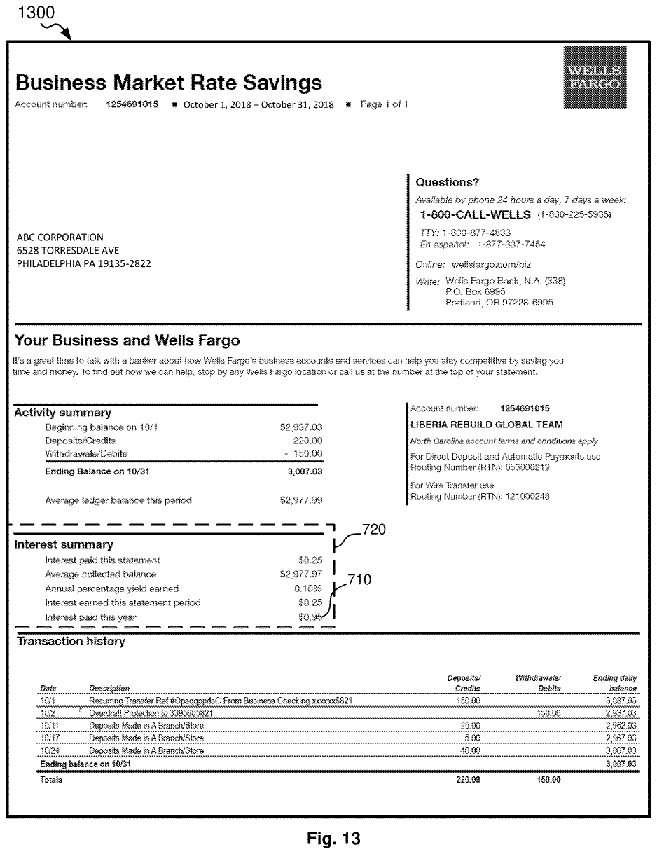

FIG. 11 illustrates source document 500 displayed as a display object 1100 on a user device, according to an embodiment. FIG. 12 illustrates source document 600 displayed as a display object 1200 on a user device, according to an embodiment. FIG. 13 illustrates source document 700 displayed as a display object 1300 on a user device, according to an embodiment.

In one embodiment, the position indication comprises an arrow indicating the position of the component data item in the source document. For example, in FIG. 11, display object 1100 has been annotated, by the application 180, with arrow 520, to visually indicate the position of the component data item $45.32 within the source document 500.

In one embodiment, the position indication comprises a rectangle which encompasses (or partially encompasses) the component data item in the source document. For example, in FIG. 12, display object 1200 has been annotated, by the application 180, with dashed line rectangle 620, to visually indicate the position of the component data item $1.49 within the source document 600. Dashed line rectangle encompasses the position of the component data item 610 as well as text associated with the component data item.

In another example, illustrated in FIG. 13, display object 1300 has been annotated, by the application 180, with dashed line rectangle 720, to visually indicate the position of the component data item $0.95 within the source document 700. Dashed line rectangle encompasses the position of the component data item 610 as well as the entire table in which the component data item is located.

In embodiments, the position indication may comprise: highlighting the component data item; annotating the display object to change the colour of the text of the data item; applying a background effect to the data item; underlining the data item; labelling the data item; applying any effect which visually distinguishes the component data item from other data items shown in the source document; or any combination of one or more of these aspects.

### Forward Traceability

A user of the accounting system 160 may desire to determine how a data item from a source document was applied by the accounting system to calculate accounting data. In embodiments, forward traceability for a component data item comprises determining the one or more calculated data items that were calculated, by the accounting system 160, based on the component data item.

In embodiments, the application 180 provides the user with the ability to select a component data item, and in response to the user selecting a component data item, the application displays, to the user, an indication of the one or more calculated data items that the accounting system calculated based on the component data item.

In embodiments, if the component data item has not been used by the accounting system to calculate a calculated data item, in response to the user selecting the component data item, the application displays, to the user, an indication that the component data item has not been used to calculate a calculated data item (e.g. that the component data item does not have forward traceability). Advantageously, this indication may inform the user as to whether a component data item has been used by the accounting system or not. Advantageously, indicating an absence of forward traceability for a component data item may assist the user to perform accounting operations in relation to the component data item.

Being able to perform backward traceability and/or forward traceability may be an important step for enhancing accountability, verification, validation, auditing and education of an accounting system.

### Example Forward Traceability

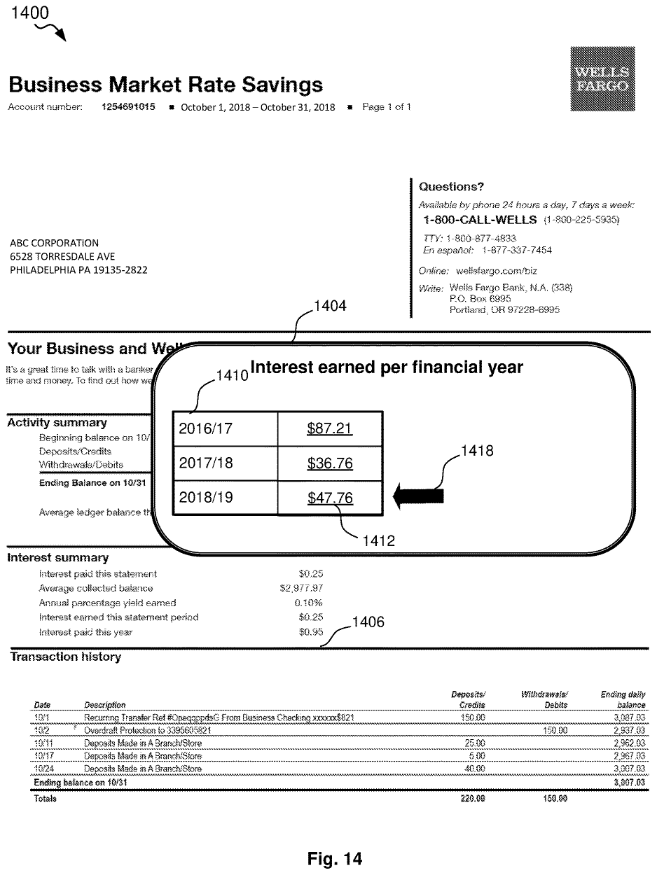

FIG. 14 illustrates a display object 1400, comprising a source document 1402, according to an embodiment.

FIG. 18 illustrates a process flow diagram for a process to visually indicate a calculated data item associated with a component data item, according to an embodiment. Process 1800 may be performed by application 180.

In operation 1802, the application 180 displays a source document 1402, comprising at least one text item 1408, the text item representing a component data item. The source document 1402 comprises a plurality of text items. The text items may have been extracted by the data extraction module 150 to produce data items. At least some of the data items may be used by the accounting system 160, as component data items, to calculate calculated data items.

In operation 1804, the application 180 receives, via the user interface, a selection of a position 1406 within the source document 1402 (e.g. the position in which the text item representing interest value $0.95 is located).

In operation 1806, in response to the user selecting a position 1406 within the source document 1402, the application 180 determines the text item 1408 associated with that position (e.g. interest value $0.95). Furthermore, the application determines the data structure of the extracted data item, stored in data storage 122, which is associated with that text item.

In operation 1808, from the data structure of the component data item, the application determines the one or more calculated data items calculated by the accounting system based on the component data item. For this example, the application determines the calculated data item $47.76 which represents the interest paid to date for financial year 2018/19.

In operation 1810, the application provides the user with a visual indication of the calculated data item. In particular, the application displays pop-up window 1404 which comprises table 1410 including calculated data item 1412.

The table 1410 also comprises calculated data items 1414 and 1416 which are not calculated data items with respect to component data item 1408. Accordingly, to visually indicate to the user the calculated data item associated with component data item 1408, the application annotates the pop-up window 1404 with a visual indication (e.g. arrow) 1418.

### Data Structures

FIG. 15 illustrates a first data structure 1500 for storing information associated with a calculated data item, and a second data structure 1501 for storing information associated with a component data item, according to an embodiment. In particular, data structure 1500 is configured to store information defining an association between the calculated data item and its associated component data item. Data structure 1501 is configured to store information defining an association between a component data item and the source document from which the component data item was extracted. Furthermore, data structure 1501 is configured to store information defining an association between the component data item and the calculated data item.

Each rectangle in FIG. 15 represents an element of information within a data structure. Data structures 1500 and 1501 may be defined by the application 180, and stored in data storage 122.

Data structure 1500 comprises a data item identifier 1502, which identifies the calculated data item. In one embodiment, the data item identifier 1502 uniquely identifies the calculated data item from all other data items stored in the general ledger.

Data structure 1500 further comprises an indication of a value 1504 for the calculated data item. With reference to the example illustrated in FIG. 8, the numerical value 1504 may comprise the value 47.76.

The value of a calculated data item may be determined by the application 180 by performing an operation on one or more component data items. The operation may comprise: a calculation performed on one or more component data items; an aggregation of component data items; a combination of component data items; a mutation of component data items; a transformation of component data items; another type of operation; or any combination thereof. The value may comprise: a numerical value; alphanumeric value; a string; a date; a data range; a plurality of values; another value type; or any combination thereof.

In some embodiments, the data structure 1500 may further comprise elements that define the currency, units or other attributes of the calculated data item.

Data structure 1500 further comprises elements, indicated by bracket 1540, which define one or more component data items associated with the calculated data item identifier 1502. In particular, the calculated data item described by data structure 1500 is associated with at least three component data items, respectively identified by data item identifier 1508, data item identifier 1510 and data item identifier 1512.

With reference to the example illustrated in FIG. 8: the data item identifier 1508 may identify the interest value $45.32, as provided in source document 500; the data item identifier 1510 may identify the interest value $1.49, as provided in source document 600; and the data item identifier 1512 may identify the interest value $0.95, as provided in source document 700.

Data item identifier 1508 uniquely identifies the component data item from all other data items stored in the general ledger, and may be used by the application 180 to reference data structure 1501, which defines the component data item (e.g. the interest value $45.32).

Element 1516, of data structure 1501, defines the numerical value of the component data item identified by data item identifier 1508 (e.g. 45.32). A document identifier 1518 is configured to uniquely identify the source document from which component data item identifier 1508 was extracted (e.g. source document 500). In one embodiment, a document identifier uniquely identifies a source document from the plurality of source documents stored in the data storage 122.

Element 1520 defines the intra-document position of the component data item identifier 1508 within the source document identified by document identifier 1518.

Element 1522 comprises a list of data item identifiers, including at least data item identifiers 1524 and 1526, which identify calculated data items for which component data item identifier 1508 is a component data item.

Data item identifier 1524 refers to the calculated data item defined by data structure 1500. Accordingly, data item identifier 1524 is the same as data item identifier 1502.

Advantageously, the data structure 1500 provides backward traceability, enabling the application 180 to determine the component data items from which a calculated data item was derived. Component data item identifier 1508, described in data structure 1501, can be backward traced, as illustrated by dashed arrow 1560, from calculated data item identifier 1502 described in data structure 1500

Furthermore, advantageously, the data structure 1501 provides forward traceability (as illustrated at least by dashed arrows 1570 and 1580), enabling the application 180 to determine which calculated data items were derived based on a component data item.

In embodiments, a data item may be both a calculated data item, having one or more associated component data items, and a component data item from which one or more calculated data items have been calculated. Example data structure 1501 comprises elements defining associated calculated data item identifiers 1524 and 1526, as well as elements defining associated component data items 1530.

In embodiments, a data structure for a calculated data item may be configured to define all the component data items for that calculated data items, as well as define, recursively, any component data items from which a defined component data item was calculated.

### Example Data Structure

FIG. 16 illustrates a data structure 1600 which defines a component data item extracted from a source document, according to an embodiment. In this example, the data structure 1600 is defined using JavaScript Object Notation (JSON). In other examples, any format for representing structured data could be used, for instance, Extensible Markup Language (XML) or the like.

The data structure 1600 defines: a value of the component data item 1602 (e.g. 125.00); an identifier of the component data item 1604; an indication of the source document from which the component data item was extracted 1606; and an indication of a position of the component data item within the source document from which it was extracted 1608.

The position information 1608 indicates that the component data item is located on page numbered 2 of the source document. Furthermore, the position definition indicates that the component data item is located within a rectangular area, which is defined by: a distance from the top of a page; a distance from the left hand side of the page; a width of the rectangle; and a height of the rectangle. In embodiments, a distance and/or a width comprises a page-size relative proportion of the width or height of a page of the source document. In embodiments, a position indication may comprise a distance and/or width represented in a unit of measurement such as: pixels; centimetres; millimetres; inches; rems (font relative units); other units of measurement; or some combination thereof.

In another embodiment, a position indication may define a precise point within a page of the source document. In another embodiment, a position indication may define a region within the source document.

### Backward Traceability Process

FIG. 17 illustrates a process flow diagram for a process to visually indicate a component data item associated with a calculated data item, according to an embodiment. Process 1700 may be performed by application 180. An example of application 180 performing process 1700 is described in relation to FIGS. 8 to 13.

In operation 1702, the application displays, on a display device 140, a display object comprising a calculated data item, the calculated data item having a value determined based on at least one component data item. The component data item being extracted from a source document.

In operation 1704, the application receives from a user interface, a selection of a calculated data item (e.g. calculated data item 804).

In operation 1706, in response to receiving, from a user interface, a selection of the calculated data item 804, the application 180 determines the component data item 710 associated with the calculated data item 804.

Optionally, in operation 1706, in response to receiving, from a user interface, a selection of the calculated data item 804, the application 180 determines a plurality of candidate component data items (e.g. indicated by 904, 906, 908) associated with the candidate data item 804. In optional operation 1708, the application then displays an indication of each of the plurality of candidate component data items. In optional operation 1710, the application receives, from the user interface, a selection of a candidate component data item, and assigns the selected candidate component data item as the component data item for the remaining operations of process 1700.

In operation 1712, the application 180 determines the source document 700 (e.g. as indicated by document identifier 1518) associated with component data item 710.

In operation 1714, the application 180 displays, on the display device, at least a portion of the source document 700.

In operation 1716, the application 180 visually indicates 720, on the display device, a location of the component data item 710 in the source document 700.

It will be appreciated by persons skilled in the art that numerous variations and/or modifications may be made to the above-described embodiments, without departing from the broad general scope of the present disclosure. Furthermore, it will be appreciated by persons skilled in the art that embodiments disclosed herein can be combined with one or more other embodiments disclosed herein, without departing from the broad general scope of the present disclosure. The present embodiments are, therefore, to be considered in all respects as illustrative and not restrictive.

It will be appreciated by persons skilled in the art that any suitable distribution of functionality between different functional units may be used without detracting from the invention. For example, functionality illustrated to be performed by separate computing devices may be performed by the same computing device. Likewise, functionality illustrated to be performed by a single computing device may be distributed amongst several computing devices. Hence, references to specific functional units are only to be seen as references to suitable means for providing the described functionality, rather than indicative of a strict logical or physical structure or organization.

It will be appreciated by persons skilled in the art that, for processes and methods disclosed herein, the operations performed in the processes and methods may be implemented in differing order. Furthermore, the outlined steps and operations are only provided as examples, and some of the steps and operations can be optional, combined into fewer steps and operations, or expanded into additional steps and operations without detracting from the essence of the disclosed embodiments.

References herein to software or executable instructions are to be understood as referring to executable instructions stored in volatile or non-volatile memory. The memory can include any data storage device that can store data which can thereafter be read by a processor. Examples of memory include read-only memory (ROM), random-access memory (RAM), magnetic tape, optical data storage device, flash storage devices, or any other suitable storage devices.

Throughout this specification the word ‘comprise’, or variations such as ‘comprises’ or ‘comprising’, will be understood to imply the inclusion of a stated element, integer or step, or group of elements, integers or steps, but not the exclusion of any other element, integer or step, or group of elements, integers or steps.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the element or component is present unless it is obvious that it is meant otherwise.

Unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

1. A method for displaying data to a user, the method comprising:
displaying, on a display device, a display object comprising a calculated data item, the calculated data item having a value determined based on at least one component data item, the component data item extracted from a source document; and
in response to receiving, from a user interface, a selection of the calculated data item:
determining the component data item associated with the calculated data item;
determining the source document associated with the component data item;
displaying, on the display device, at least a portion of the source document; and
visually indicating, on the display device, a location of the component data item in the source document.

2. The method of claim 1, wherein determining the component data item associated with the calculated data item comprises:
determining a plurality of candidate component data items associated with the calculated data item;
displaying, on the display device, an indication of each component data item of the plurality of candidate component data items for the user to select; and
in response to receiving, from the user interface, a selection of a candidate component data item of the plurality of candidate component data items:
assigning the selected candidate component data item as the component data item.

3. The method of claim 1, further comprising, performing an extracting process on the source document, the extracting process comprising:
determining a value of the component data item;
determining the location of the component data item in the source document; and
storing the value of the component data item and the location of the component data item in a data storage.

4. The method of claim 3, further comprising:
allocating an identifier of the component data item to the component data item; and
storing the identifier of the component data item in association with the component data item in the data storage.

5. The method of claim 4, wherein determining the source document comprises determining the identifier of the component data item.

6. The method of claim 4, wherein the identifier of the component data item comprises an indication of the source document.

7. The method of claim 4, wherein the identifier of the component data item comprises an indication of the location of the component data item within the source document.

8. The method of claim 4, wherein the identifier of the component data item comprises a reference to the source document and the location within the source document.

9. The method of claim 1, wherein the source document comprises a digital financial document.

10. The method of claim 1, wherein determining the component data item associated with the calculated data item comprises:
determining an identifier of the calculated data item; and
determining, based on the identifier of the calculated data item, the component data item associated with the calculated data item.

11. The method of claim 1, wherein the location comprises one or more of:
a region of the source document;
a landmark of the source document;
a set of coordinates within the source document; and
a page number of the source document.

12. The method of claim 1, wherein visually indicating the location comprises visually indicating on the at least a portion of the source document displayed on the display device.

13. The method of claim 1, wherein visually indicating the location comprises one or more of:
highlighting text representing the component data item in the source document;
underlining the text representing the component data item in the source document;
altering a colour of the text representing the component data item in the source document; and
annotating the source document with a visual indication of a location within the source document.

14. The method of claim 1, further comprising:
determining the value of the calculated data item by performing an operation on at least the component data item.

15. The method of claim 1, wherein the display object comprises an accounting record.

16. The method of claim 1, further comprising:
displaying a second source document, comprising at least one text item, the text item representing a second component data item; and
in response to receiving, from a user, a selection of the at least one text item:
determining the second component data item represented by the text item;
determining at least one second calculated data item whose value was determined based on the second component data item; and
displaying, on the display device, a visual indication of the at least one second calculated data item.

17. The method of claim 16, wherein the visual indication of the at least one second calculated data item comprises an indication of the value of the second calculated data item.

18. The method of claim 16, wherein the visual indication of the at least one second calculated data item comprises at least a portion of an accounting record comprising the second calculated data item.

19. A non-transitory machine-readable storage medium storing instructions which, when executed by one or more processors, individually or in combination, cause the one or more processors to perform a method comprising:
displaying, on a display device, a display object comprising a calculated data item, the calculated data item having a value determined based on at least one component data item, the component data item extracted from a source document; and
in response to receiving, from a user interface, a selection of the calculated data item:
determining the component data item associated with the calculated data item;
determining the source document associated with the component data item;
displaying, on the display device, at least a portion of the source document; and
visually indicating, on the display device, a location of the component data item in the source document.

20. A system comprising:
one or more processors; and
memory comprising computer executable instructions, which when executed by the one or more processors, individually or in combination, cause the system to:
display, on a display device, a display object comprising a calculated data item, the calculated data item having a value determined based on at least one component data item, the component data item extracted from a source document; and
in response to receiving, from a user interface, a selection of the calculated data item:
determine the component data item associated with the calculated data item;
determine the source document associated with the component data item;
display, on the display device, at least a portion of the source document; and
visually indicate, on the display device, a location of the component data item in the source document.
